(19) United States
(12) Patent Application Publication
(10) Pub. No.: US 2026/0228085 A1
(43) Pub. Date: Aug. 6, 2026

(54) BOOT-CORE TRANSITIONING FOR BOOT KEY PERFORMANCE INDICATOR (KPI) IMPROVEMENT AND ROBUSTNESS IN COLD-BOOT EQUIVALENT STATES EXIT

(71) Applicant: QUALCOMM Incorporated, San Diego, CA (US)

(72) Inventors: Dinesh Kumar CHOUDHARY, Tonk (IN); Maulik SHAH, Hyderabad (IN)

(21) Appl. No.: 19/047,531

(22) Filed: Feb. 6, 2025

(51) Int. Cl. G06F 11/14; G06F 9/445

(52) U.S. Cl. CPC G06F 11/1417; G06F 9/44505

(57) ABSTRACT

A method for deep-sleep mode operation is described. The method includes initiating a quick-boot to exit from a deep-sleep mode of a system-on-chip (SoC) having multiple cores. The method also includes restoring a configuration saved by a last core prior to entry of the SoC into the deep-sleep mode. The method further includes enabling the last core that configured the SoC for the deep-sleep mode. The method also includes enabling the multiple cores and drivers to transition the SoC to an active mode.

### BACKGROUND

### Field

Aspects of the present disclosure relate to semiconductor devices and, more particularly, to a system and method for boot-core transitioning for boot key performance indicator (KPI) improvement and robustness in cold-boot equivalent states exit.

### Background

Modern-day processors are equipped with multiple cores, which range from efficient, in-order-execution to super/hyper scalar architectures. The number of cores in modern-day processors has steadily risen from single, dual/quad core systems in mobile processors to an expanded number of processor cores in server compute-platforms. A system-on-chip (SoC) may include multiple processor cores/processor clusters for executing real-world applications. These real-world applications drive the complexity of SoCs due to an ever-increasing demand for additional numbers of processor cores/processor clusters for meeting performance benchmarks.

During operation, these multi-processor and multi-cluster hierarchy systems utilize multiple low power states. For example, these low power states may include a deep-sleep mode, which is a power state specifically designed for long duration sleep cycles. An exit from the deep-sleep power state is referred to as a quick-boot. In practice, although a last core configures an SoC for the deep-sleep mode, a fixed boot-core is configured to perform an exit from the deep-sleep mode. Unfortunately, the boot loader executed by the boot central processing unit (CPU) or control processor CPU (CPCPU) is unaware of the last core that configured the SoC for the deep-sleep mode. A system and method for improved efficiency during an exit from the deep-sleep mode are desired.

### SUMMARY

A method for deep-sleep mode operation is described. The method includes initiating a quick-boot to exit from a deep-sleep mode of a system-on-chip (SoC) having multiple cores. The method also includes restoring a configuration saved by a last core prior to entry of the SoC into the deep-sleep mode. The method further includes enabling the last core that configured the SoC for the deep-sleep mode. The method also includes enabling the multiple cores and drivers to transition the SoC to an active mode.

A non-transitory computer-readable medium having program code recorded thereon for deep-sleep mode operation is described. The program code is executed by a processor. The non-transitory computer-readable medium includes program code to initiate a quick-boot to exit from a deep-sleep mode of a system-on-chip (SoC) having multiple cores. The non-transitory computer-readable medium also includes program code to restore a configuration saved by a last core prior to entry of the SoC into the deep-sleep mode. The non-transitory computer-readable medium further includes program code to enable the last core that configured the SoC for the deep-sleep mode. The non-transitory computer-readable medium also includes program code to enable the multiple cores and drivers to transition the SoC to an active mode.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for boot-core transitioning in deep-sleep mode, in accordance with aspects of the present disclosure.

FIG. 2 is a block diagram illustrating a multi-core subsystem of the system-on-chip (SoC) of FIG. 1, including trusted firmware to support boot-core transitioning in deep-sleep mode, according to various aspects of the present disclosure.

FIG. 3 is a block diagram illustrating a virtual machine (VM) multi-core subsystem of the system-on-chip (SoC) of FIG. 1, including trusted firmware to support boot-core transitioning in deep-sleep mode, according to various aspects of the present disclosure.

FIG. 4 is a process flow diagram illustrating a framework for swapping a boot-core with a last core without impacting boot-time, according to various aspects of the present disclosure.

FIG. 5 is a process flow diagram illustrating a framework for swapping a boot-core with a last core, according to various aspects of the present disclosure.

FIG. 6 is a process flow diagram illustrating a method for deep-sleep mode operation, according to various aspects of the present disclosure.

FIG. 7 is a block diagram showing an exemplary wireless communications system in which an aspect of the disclosure may be advantageously employed.

FIG. 8 is a block diagram illustrating a design workstation used for circuit, layout, and logic design of a semiconductor component, such as the disclosed boot-core transitioning in deep-sleep mode.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced.

Modern-day processors are equipped with multiple cores, which range from efficient, in-order-execution to super/hyper scalar architectures. The number of cores in modern-day processors has steadily risen from single, dual/quad core systems in mobile processors to an expanded number of processor cores in server compute-platforms. A system-on-chip (SoC) may include multiple processor cores/processor clusters for executing real-world applications. These real-world applications drive the complexity of SoCs due to an ever-increasing demand for additional numbers of processor cores/processor clusters for meeting performance benchmarks.

During operation, multi-processor and multi-cluster hierarchy systems utilize multiple low power states. For example, these low power states may include clock-gating as well as power collapse. These low power states are introduced at each level and have associated residency/latency specifications. Selection of different states supported by the SoC which may depend on a predicted sleep duration. In practice, the desired idle states are selected for the different cores/clusters in the multi-processor/multi-cluster hierarchy systems based on the associated residency/latency specifications.

In practice, these multi-processor and multi-cluster hierarchy systems utilize multiple low power states, which may include a deep-sleep mode. As described, deep-sleep mode is a power state specifically designed for long duration sleep cycles. An exit from the deep-sleep mode is referred as a quick-boot. During operation, a last core configures an SoC for entering the deep-sleep mode; although the last core configured the SoC for the deep-sleep mode, a fixed boot-core is specified to perform an exit from the deep-sleep mode. Unfortunately, the boot loader executed by the boot central processing unit (CPU) or control processor CPU (CPCPU)is unaware of the last core that configured the SoC for the deep-sleep mode. A system and method for improved efficiency during an exit from the deep-sleep mode are desired.

Various aspects of the present disclosure provide a framework for swapping the boot-core with the last core without impacting the boot-time, which is a key performance indicator (KPI) of SoCs, such as a cold-boot KPI. In some implementations, a solution is targeted in secure firmware to save SoC configuration information as well as a core number of the last core in a retention memory. This implementation provides a robust solution in which restrictions are not imposed on a last core that configures the deep-sleep mode across different virtual machines.

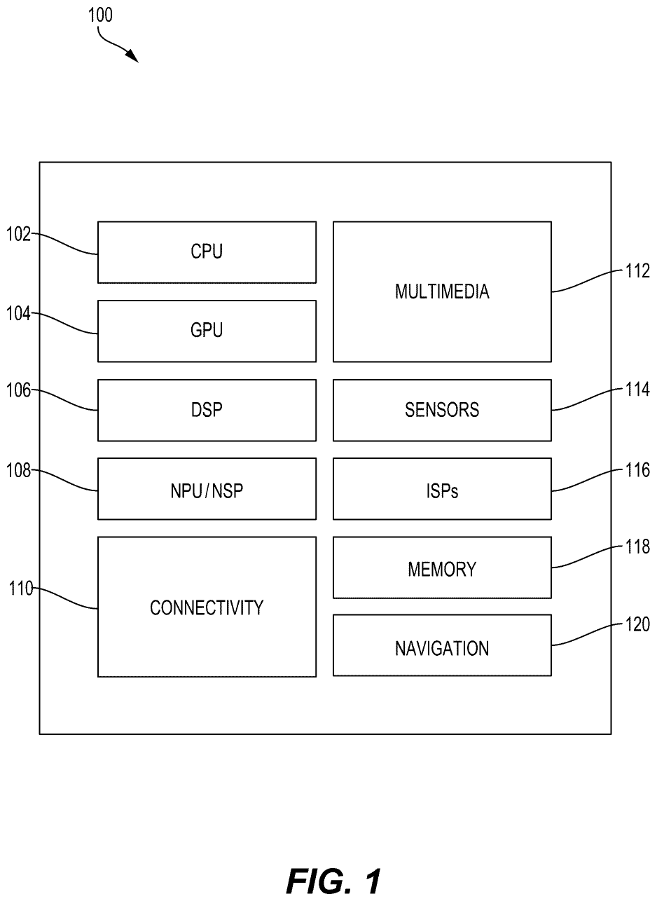

FIG. 1 illustrates an example implementation of a host system-on-chip (SoC) 100, which is configured for boot-core transitioning in deep-sleep mode, in accordance with aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU/NSP 108 may be based on an ARM instruction set.

The multi-core CPU 102 is equipped with multiple cores, which may range from efficient, in-order-execution to super/hyper scalar architectures. The number of cores in the multi-core CPU 102 may range from eight (8) processor cores in a mobile processor implementation to ninety-six (96) processor cores in a server compute-platform implementation of the host SoC 100. The host SoC 100 may include multiple processor cores/processor clusters executing real-world applications. The real-world applications drive the complexity of the host SoC 100 due to an ever-increasing demand for additional numbers of processor cores/processor clusters for meeting performance benchmarks.

As described, deep-sleep (DS) is a new power state specially designed for long duration sleep cycles (e.g., for automotive devices or wearable devices) in a system-on-chip (SoC), which is also planned for mobile platforms. As further described, an exit from a deep-sleep mode is referred to as a quick-boot. During operation, power saving is generally maximized when an SoC is turned off; however, the power savings provided by powering down the SoC comes at the cost of a cold-boot, which exhibits an increased boot-up time. Deep-sleep mode is a cold-boot equivalent state but provides reduced boot-time relative to a cold-boot; however, at the cost of reduced power savings compared to turning off the SoC.

As noted, an exit from a deep-sleep mode is referred to as quick-boot. In practice, a quick-boot exit from a deep-sleep mode exhibits a reduced boot-time relative to a cold-boot with less power savings. Another power saving mode is a rock-bottom supply current (RBSC) mode, which provides less power savings and a reduced boot-up time relative to deep-sleep mode. Other power saving modes include regular low power modes (LPMs), which provide less power savings and a reduced boot-up time relative to RBSC mode. Due to their reduced power savings, the RBSC mode as well as regular LPMs are unsatisfactory for long duration sleep cycles because the modes may result in draining of a battery. Additionally, an increased boot-up time during a cold-boot to restart an SoC may fail to meet a boot-time key performance indicator (KPI) of certain applications (e.g., automotive/wearable).

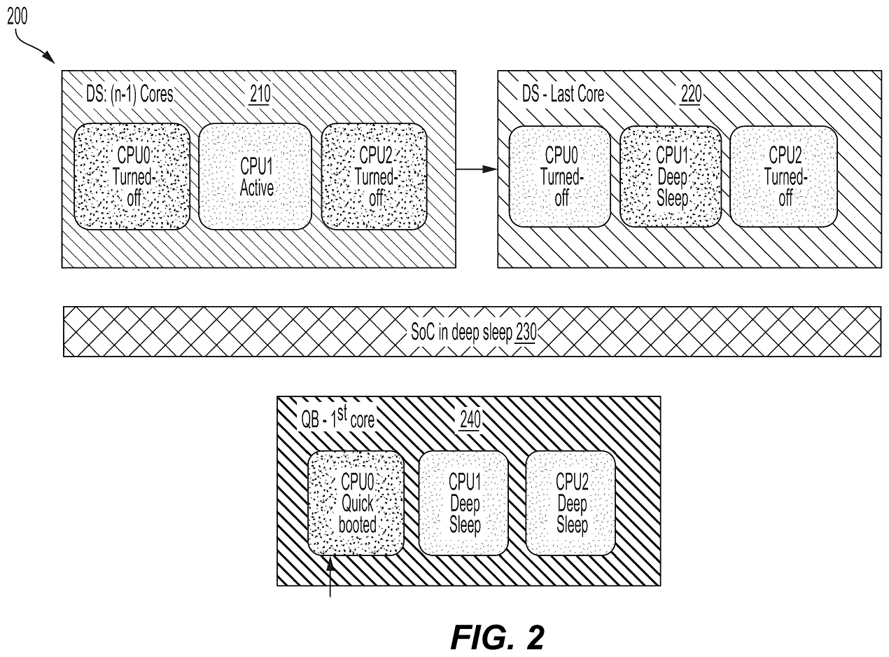

FIG. 2 is a block diagram illustrating a multi-core subsystem 200 of the system-on-chip (SoC) 100 of FIG. 1, including trusted firmware to support boot-core transitioning in deep-sleep mode, according to various aspects of the present disclosure. As noted above, during deep-sleep mode, the entire SoC 100 is turned off and the configuration information of the SoC 100, as well as a core number of the last core is saved in a retention memory (e.g., a double data rate (DDR) dynamic random-access memory (DRAM). In practice, a quick-boot process (e.g., exit from a deep-sleep mode) takes advantage of the retention memory for performing a faster boot-up.

As shown in FIG. 2, the multi-core subsystem 200 of the SoC 100 of FIG. 1 is implemented as a multi-processor system, having n-1 cores 210, in which a last core 220 configures the multi-core subsystem 200 of the SoC 100 for deep-sleep (DS) mode 230. As shown in FIG. 2, CPU0 and CPU2 are turned off and CPU1 of the n-1 cores 210 is in an active mode when a deep-sleep mode 230 is triggered. In response, CPU1 is the last core 220. As a result, CPU1 is responsible for configuring multiple settings for the multi-core subsystem 200 of the SoC 100 to enter the deep-sleep mode 230. Additionally, each interrupt and task from the n-1 cores 210 is migrated to CPU1 because CPU1 is in a suspended state (e.g., deep-sleep state) and the other n-1 cores 210 are in an off-state (e.g., turned-off) during the deep-sleep mode 230.

According to various aspects of the present disclosure, CPU1 in the last core 220 is expected to control wake-up of the multi-core subsystem 200 of the SoC 100 from the deep-sleep mode 230, as CPU0 and CPU2 were turned off during entry into the deep-sleep mode 230. In practice, an exit from the deep-sleep mode 230 is generally performed as a cold-boot, in which the same boot-core of the SoC 100 is configured to perform the exit from the deep-sleep mode 230. In particular, the boot-core is fixed in the SoC 100 based on floor plan as well as other parameters and metrics including, but not limited to, a boot-up time. As shown FIG. 2, CPU0 is hardwired as a boot-core 240 (e.g., according to the quick-boot (QB) first core scheme), while CPU1 (in the last core 220) and CPU2 are in deep-sleep mode 230. Unfortunately, the boot-core 240 is CPU0, which is unaware of the last core 220 that configured/entered the SoC 100 into the deep-sleep mode 230.

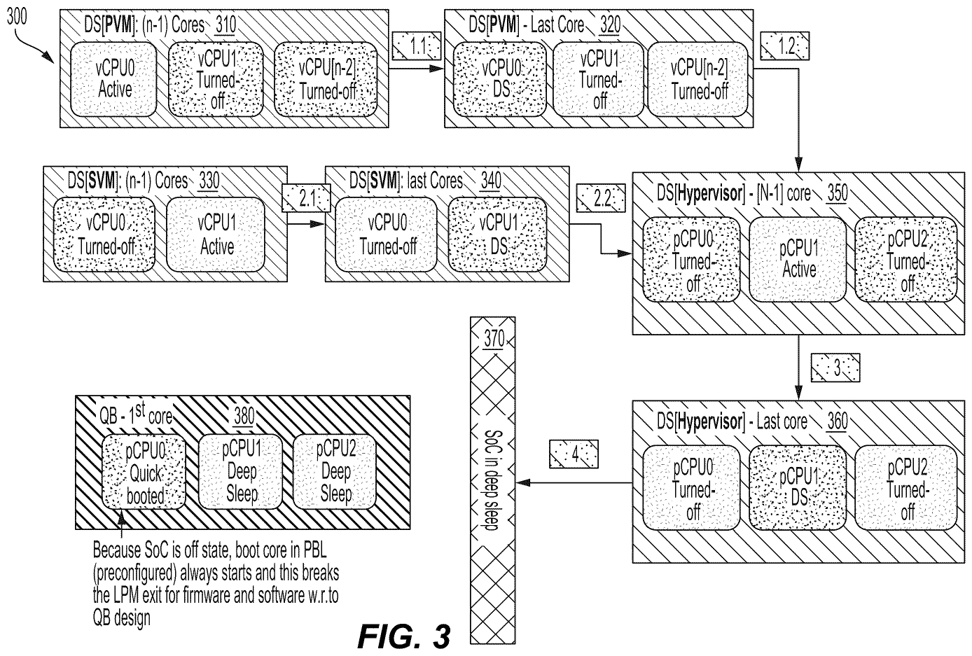

FIG. 3 is a block diagram illustrating a virtual machine (VM) multi-core subsystem 300 of the system-on-chip (SoC) 100 of FIG. 1, including trusted firmware to support boot-core transitioning in deep-sleep mode, according to various aspects of the present disclosure. As shown in FIG. 3, the VM multi-core subsystem 300 of the SoC 100 of FIG. 1 is implemented as a multi-processor virtual machine system, including a primary virtual machine (PVM) 310 having n-1 virtual cores (e.g., vCPU0, vCPU1, . . . , vCPU[n-2]). Similarly, a last virtual core 320 of the PVM 310 configures the VM multi-core subsystem 300 of the SoC 100 for a deep-sleep mode 370 at step 4.

As shown in FIG. 3, vCPU1 and vCPU[n-2] are turned off and vCPU0 of the n-1 virtual cores of the PVM 310 is active when the deep-sleep mode 370 is triggered at step 1.1. In response, vCPU0 is the last virtual core 320, which is responsible for configuring multiple settings for the VM multi-core subsystem 300 of the SoC 100 at step 1.2 to enter the deep-sleep mode 370. Additionally, each interrupt and task from the n-1 virtual cores of the PVM 310 is migrated to vCPU0 because vCPU0 is in a suspended state (e.g., deep-sleep state) and the other n-1 virtual cores of the PVM 310 are in an off-state (e.g., turned-off) during the deep-sleep mode 370.

As further illustrated in FIG. 3, the VM multi-core subsystem 300 of the SoC 100 of FIG. 1 includes n-1 virtual cores (e.g., vCPU0, vCPU1) of a shared virtual machine (SVM) 330, in which a last virtual core 340 of the SVM 330 configures the VM multi-core subsystem 300 of the SoC 100 for the deep-sleep mode 370. In this example, vCPU0 is turned off and vCPU1 of the n-1 virtual cores of the SVM 330 is active when the deep-sleep mode 370 is triggered at step 2.1. In response, vCPU1 is the last virtual core 340 of the SVM 330 at step 2.2, which is responsible for configuring multiple settings for the VM multi-core subsystem 300 of the SoC 100 to enter the deep-sleep mode 370. Additionally, each interrupt and task from the n-1 virtual cores of the SVM 330 is migrated to vCPU1 because vCPU1 is in a suspended state (e.g., deep-sleep state) and vCPU0 is turned off during the deep-sleep mode 370.

In this example, the VM multi-core subsystem 300 further includes a hypervisor 350 having N-1 cores (e.g., pCPU0, pCPU1, pCPU2). As shown in FIG. 3, pCPU0 and pCPU2 are turned off and pCPU1 of the N-1 cores of the hypervisor 350 is active when the deep-sleep mode 370 is triggered. In response, pCPU1 is a last core 360 at step 3. As a result, pCPU1 is responsible for configuring multiple settings for the VM multi-core subsystem 300 of the SoC 100 to enter the deep-sleep mode 370. Additionally, each interrupt and task from the N-1 cores of the hypervisor 350 is migrated to pCPU1 because pCPU1 is in a suspended state (e.g., deep-sleep state) and the other N-1 cores of the hypervisor 350 are in an off-state during the deep-sleep mode 370.

During operation, the PVM 310 generally maps to a root operating system (OS) and, in response, to a deep-sleep trigger at step 1.1 determines a boot-core (e.g., vCPU0) as the last virtual core 320 to enter the deep-sleep mode 370 at step 1.2. In this example, the SVM 330 is active at step 2.1 and identifies a non-boot-core (e.g., vCPU1) as the last virtual core 340 at step 2.2. At step 3, the hypervisor 350 aggregates and designates pCPU1 (a non-boot-core) as the last core 360 and triggers the deep-sleep mode 370 at step 4. During the deep-sleep mode 370, a kernel operating system (OS) and secure firmware migrate all interrupts and tasks from the N-1 cores of the hypervisor 350 to the last core 360 (e.g., pCPU1) and save a context of the SoC 100, which is passed as part of a core register space.

According to various aspects of the present disclosure, the last core 360 (e.g., pCPU1) is expected to control wake-up of the VM multi-core subsystem 300 of the SoC 100 from the deep-sleep mode 370 because pCPU0 and pCPU2 were turned off during entry into the deep-sleep mode 370 at step 4. In practice, an exit from the deep-sleep mode 370 is generally performed as a cold-boot, in which the same boot-core of the SoC 100 is configured to perform the exit from the deep-sleep mode. In particular, the boot-core is fixed in the SoC 100 based on floor plan as well as other parameters and metrics including, but not limited to, a boot-up time.

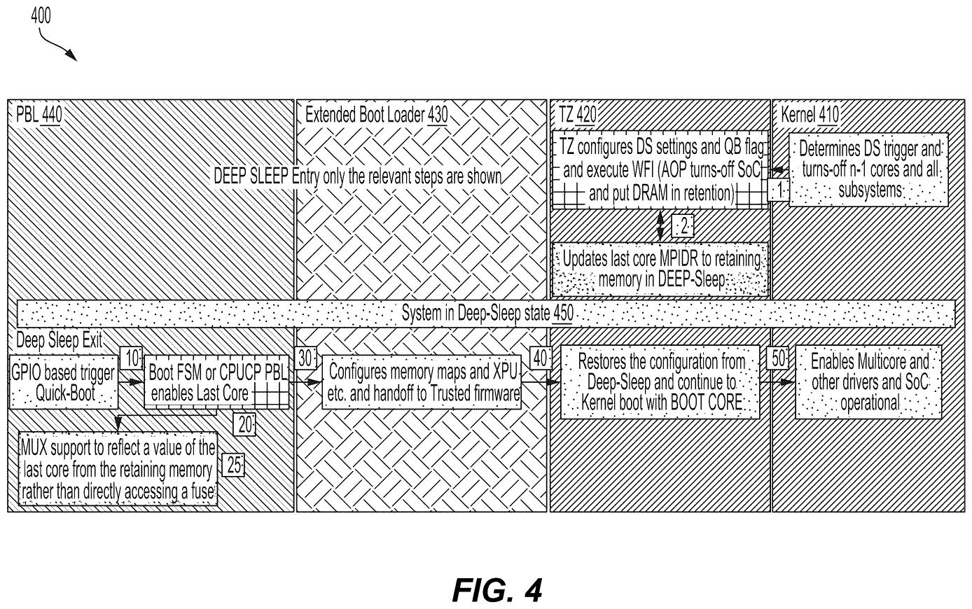

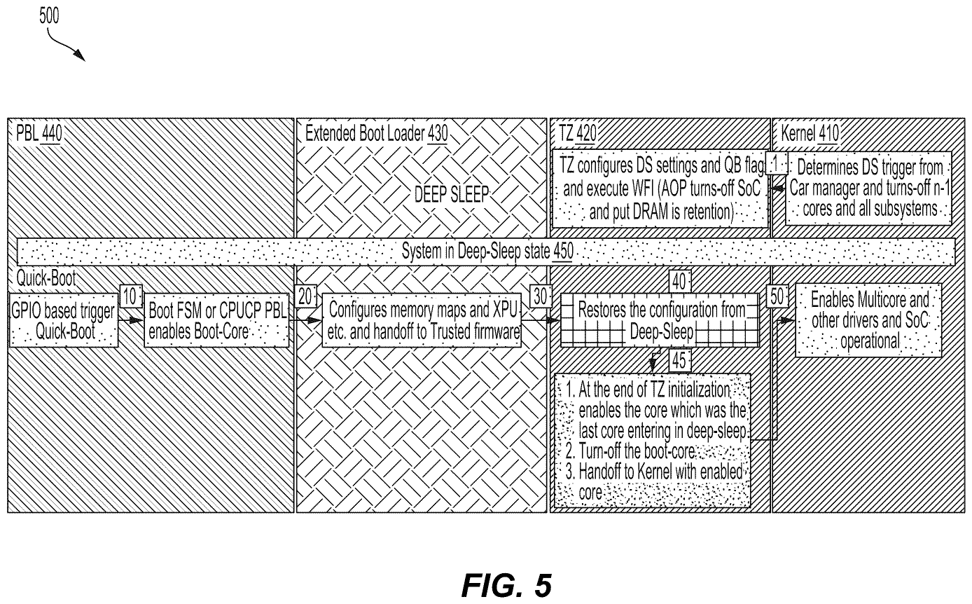

As shown in FIG. 3, vCPU0 is hardwired as a boot-core 380, while pCPU1 (e.g., the last core 360) and pCPU2 are in the deep-sleep mode 370. Unfortunately, the boot-core 380 is pCPU0, which is unaware of the last core 360 that configured/entered the SoC 100 into the deep-sleep mode 370 at step 4. In various aspects of the present disclosure, a solution is targeted in secure firmware to save SoC configuration information as well as a core number of the last core in a retention memory, for example, as shown in FIG. 4. Some implementations provide a framework for swapping the boot-core 380 with the last core 360 without detrimentally impacting the boot-time, which is a key performance indicator (KPI) of SoCs, such as a cold-boot KPI, for example, as shown in FIG. 5.

FIG. 4 is a process flow diagram 400 illustrating a framework for swapping a boot-core with a last core without impacting boot-time, according to various aspects of the present disclosure. As shown in the process flow diagram 400, at step 1, a kernel operating system (OS) 410 (e.g., root OS and hypervisor) detects a deep-sleep trigger (e.g., an off-state from a vehicle manager according to a vehicle ignition) and turns off N-1 cores and all subsystems of a system-on-chip (SoC). It should be recognized that the framework for swapping the boot-core with the last core shown in FIG. 4 omits a unified extensible firmware interface (UEFI) phase as well as a modem peripheral subsystem (MPSS) phase, as these phases are not relevant to the deep-sleep entry process.

At step 2, a trusted firmware trust zone (TZ) 420 configures deep-sleep (DS) settings as well as a quick-boot (QB) flag and executes a wait for interrupt (WFI) operation. In response, an always-on-processor (AOP) turns off the SoC and places memory (e.g., double data rate (DDR) dynamic random-access memory (DRAM)) in a retention mode. In various aspects of the present disclosure, a multi-processor affinity register (MPIDR) of the last core is updated to a retained memory (e.g., a non-volatile memory (NVM) or DDR DRAM) and the SoC enters a deep-sleep mode 450. In this implementation, storing of the MPIDR of the last core in the retained memory enables identification of the last core, rather than the hardwired boot-core, when a quick-boot is triggered to exit from the deep-sleep mode 450.

At step 10, a general-purpose input/output (GPIO) trigger of a quick-boot exit from the deep-sleep mode 450 is detected at a pre-boot loader (PBL) 440. In response, at step 20, a central processing unit (CPU) control processor (CPUCP) PBL performs a read from the retained memory to identify and enable the last core. During conventional operation, a boot finite state machine (FSM) is limited to directly accessing a fuse to identify the hardwired boot-core. At step 20, once the last core is identified, the CPUCP PBL enables the last core. According to various aspects of the present disclosure, at step 25, multiplexer (MUX) support is provided to reflect the value of the last core from the retaining memory (see step 2), rather than directly accessing the fuse to identify the hardwired boot-core by the CPUCP PBL.

At step 30, an extended boot loader (XBL) 430 utilizes the last core to configure memory maps and an external protection unit (XPU), prior to performing a handoff (e.g., handing-off) to the TZ 420. At step 40, the TZ 420 restores the configuration from deep-sleep and continues to a kernel boot with the boot-core. At step 50, the kernel OS 410 enables the multi-cores and other drivers to place the SoC in an operational mode. As noted, booting of the last core is not possible for boot FSM-based designs. According to various aspects of the present disclosure, a framework for swapping the boot-core with the last core that is supported by boot FSM-based designs is illustrated, for example, as shown in FIG. 5.

FIG. 5 is a process flow diagram 500 illustrating a framework for swapping a boot-core with a last core, according to various aspects of the present disclosure. The process flow diagram 500 is like the process flow diagram 400 shown in FIG. 4 and is described using similar reference numbers. In the process flow diagram 500 of FIG. 5, however, a trust zone (TZ) 420 is modified to enable swapping of the boot-core with the last core.

As shown in the process flow diagram 500, at step 1, a kernel operating system (OS) 410 (e.g., root OS and hypervisor) detects a deep-sleep trigger (e.g., from a vehicle manager) and turns off N-1 cores and all subsystems of a system-on-chip (SoC). Additionally, at step 1, the TZ 420 configures deep-sleep (DS) settings as well as a quick-boot (QB) flag and executes a wait for interrupt (WFI) operation. In response, an always-on-processor (AOP) turns off the SoC and places memory (e.g., double data rate (DDR) dynamic random-access memory (DRAM)) in a retention mode and the SoC enters a deep-sleep mode 450.

At step 10, a general-purpose input/output (GPIO) triggers the quick-boot exit from the deep-sleep mode 450, which is detected at a pre-boot loader (PBL) 440. In response, at step 20, a central processing unit control processor (CPUCP) PBL/boot-finite state machine (FSM) directly accesses fuses to identify a hardwired boot-core. Once the boot-core is identified, the CPUCP PBL/boot-FSM enables the boot-core.

At step 30, an extended boot loader (XBL) 430 utilizes the boot-core to configure memory maps and an external protection unit (XPU), prior to performing a handoff (e.g., handing-off) to the TZ 420. At step 40, the TZ 420 restores the configuration from the deep-sleep mode 450. According to various aspects of the present disclosure, after initialization is performed by the TZ 420, at step 45, the TZ 420 enables the core that was the last core to enter the deep-sleep mode 450. Once the last core is enabled, the boot-core is turned off and a handoff to the kernel OS 410 with the enabled last core is performed.

At step 50, the kernel OS 410 enables the multi-cores and other drivers to place the SoC in an operational mode. As noted, booting of the last core is not possible for boot-FSM-based designs. According to various aspects of the present disclosure, the core swapping performed by the TZ 420 is transparent to the kernel OS 410. In practice, the boot-core is may be a high-performance core; however, performance of a quick-boot exit with a high-performance core could lead to thermal issues. According to various aspects of the present disclosure, enabling a last core as a high-performance core does not incur thermal issues as the thermal management would be activated as part of the trust zone initialization.

Various aspects of the present disclosure provide a framework for swapping the boot-core with the last core without detrimentally impacting the boot-time, which is a key performance indicator (KPI) of SoCs, such as a cold-boot KPI. In some implementations, a solution is targeted in secure firmware to save SoC configuration information as well as a core number of the last core in a retention memory. This implementation provides a robust solution in which restrictions are not imposed on a last core that configures the deep-sleep mode across different virtual machines.

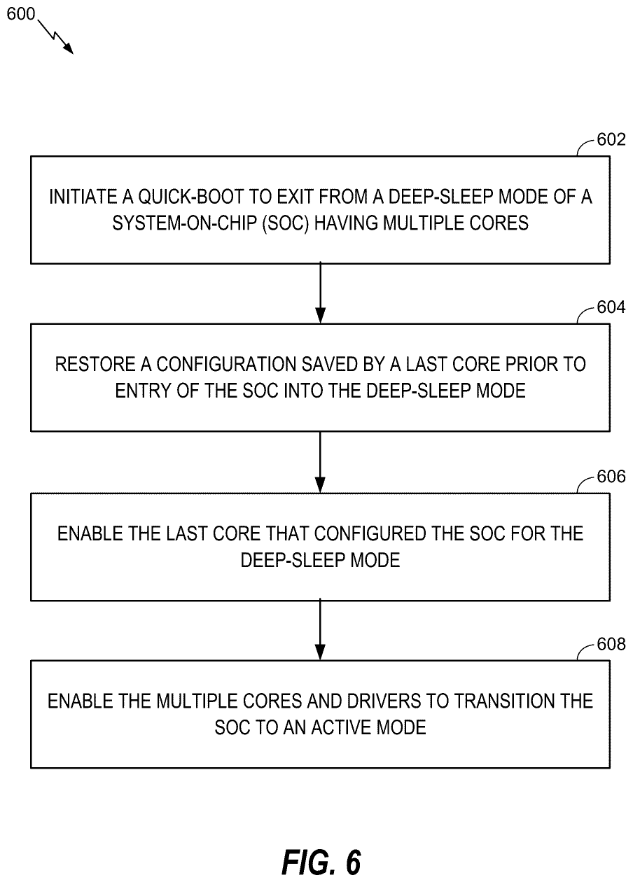

Additionally, the proposed solution is scalable across different kernels/high level operating systems (HLOSs) or multiple virtual machines running on an SoC. Low power mode (LPM) load balancing is supported because any core may be utilized as the core to enter/exit the deep-sleep mode. This solution is also extendable for extended reality (XR) and other segments in which a cold-boot KPI is very stringent by swapping the boot-core with a faster microprocessor operating millions of instructions per second (MIPS) in secure firmware. A method for deep-sleep mode operation may be performed, for example, as shown in FIG. 6.

FIG. 6 is a process flow diagram illustrating a method 600 for deep-sleep mode operation, according to various aspects of the present disclosure. The method 600 begins at block 602, in which a quick-boot is initiated to exit from a deep-sleep mode of a system-on-chip (SoC) having multiple cores. For example, as shown in FIG. 5, At step 10, a general-purpose input/output (GPIO) trigger of a quick-boot exit from the deep-sleep mode 450 is detected at a pre-boot loader (PBL) 440. At block 604 a configuration saved by a last core prior to entry of the SoC into the deep-sleep mode is restored. For example, as shown in FIG. 5, at step 40, the TZ 420 restores the configuration from the deep-sleep mode 450.

At block 606, the last core that configured the SoC for the deep-sleep mode is enabled. For example, as shown in FIG. 5, after initialization is performed by the TZ 420, at step 45, the TZ 420 enables the core that was the last core to enter the deep-sleep mode 450. Once the last core is enabled, the boot-core is turned off and a handoff to the kernel OS 410 with the enabled last core is performed. At block 608, the multiple cores and drivers are enabled to transition the SoC to an active mode. For example, as shown in FIG. 5, at step 50, the kernel OS 410 enables the multi-cores and other drivers to place the SoC in an operational mode. As noted, booting of the last core is not possible for boot-FSM-based designs. According to various aspects of the present disclosure, the core swapping performed by the TZ 420 is transparent to the kernel OS 410.

In some aspects, the method 600 may be performed by the host SoC 100 (FIG. 1). That is, each of the elements of method 600 may, for example, but without limitation, be performed by the host SoC 100 or one or more processors (e.g., multi-core CPU 102 and/or NPU 130) and/or other components included therein.

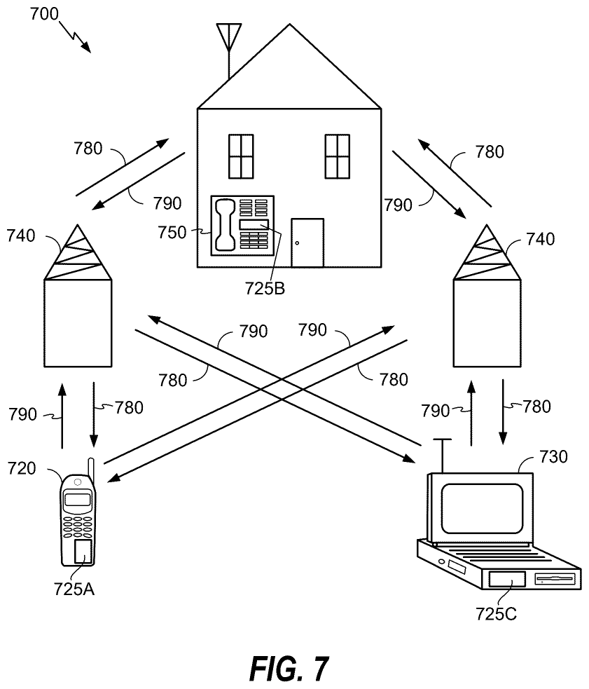

FIG. 7 is a block diagram showing an exemplary wireless communications system 700 in which an aspect of the disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include IC devices 725A, 725B, and 725C that include the disclosed boot-core transitioning in deep-sleep mode. It will be recognized that other devices may also include the disclosed boot-core transitioning in deep-sleep mode, such as the base stations, switching devices, and network equipment. FIG. 7 shows forward link signals 780 from the base stations 740 to the remote units 720, 730, and 750, and reverse link signals 790 from the remote units 720, 730, and 750 to base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to aspects of the present disclosure, the disclosure is not limited to these exemplary illustrated units. Aspects of the present disclosure may be suitably employed in many devices, which include the disclosed boot-core transitioning in deep-sleep mode.

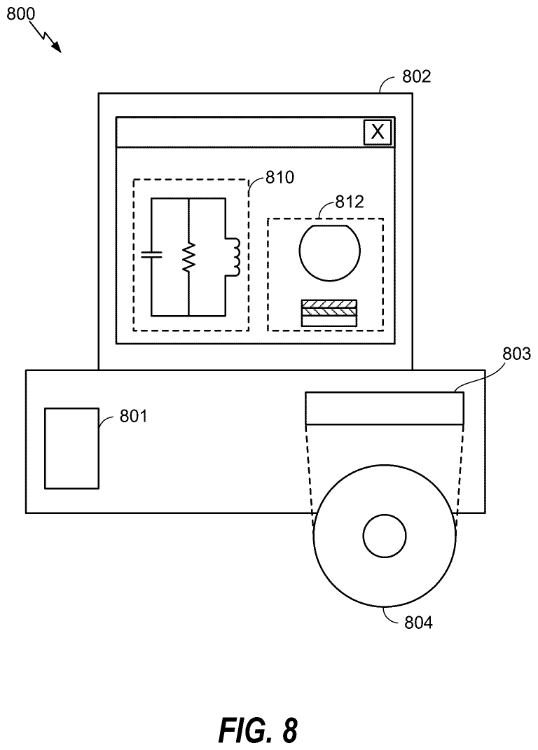

FIG. 8 is a block diagram illustrating a design workstation used for circuit, layout, and logic design of a semiconductor component, such as the boot-core transitioning in deep-sleep mode disclosed above. A design workstation 800 includes a hard disk 801 containing operating system software, support files, and design software such as Cadence or OrCAD. The design workstation 800 also includes a display 802 to facilitate design of a circuit 810 or an integrated circuit (IC) component 812 such as the interrupt controller. A storage medium 804 is provided for tangibly storing the design of the circuit 810 or the IC component 812 (e.g., the boot-core transitioning in deep-sleep mode). The design of the circuit 810 or the IC component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the IC component 812 by decreasing the number of processes for designing semiconductor wafers.

Implementation examples are described in the following numbered clauses:
1. A method for deep-sleep mode operation, the method comprising:
initiating a quick-boot to exit from a deep-sleep mode of a system-on-chip (SoC) having multiple cores;
restoring a configuration saved by a last core prior to entry of the SoC into the deep-sleep mode;
enabling the last core that configured the SoC for the deep-sleep mode; and
enabling the multiple cores and drivers to transition the SoC to an active mode.
2. The method of clause 1, in which the enabling of the multiple cores and drivers is performed by the last core.
3. The method of clause 1, in which the enabling of the last core further comprises utilizing the last core to configure memory maps and an external protection unit (XPU), prior to performing a handoff to a firmware trust zone.
4. The method of any of clauses 1-3, in which enabling of the last core further comprises disabling a boot-core enabled in response to triggering of the quick-boot.
5. The method of any of clauses 1-4, in which restoring the configuration comprises:
accessing the configuration stored in a multi-processor affinity register (MPIDR) of the last core; and
storing the configuration in a retained memory during the deep-sleep mode.
6. The method of any of clauses 1-5, in which restoring the configuration comprises:
accessing the configuration stored in a retained memory during the deep-sleep mode; and
updating an SoC configuration according to the configuration accessed from the retained memory.
7. The method of any of clauses 1-6, in which the enabling of the multiple cores and drivers comprises handing off the last core to a kernel operating system (OS).
8. The method of clause 7, in which the handing off the last core to the kernel OS is performed by trusted firmware.
9. The method of any of clauses 1-8, in which the initiating the quick-boot further comprises:
accessing a retained memory in response to triggering of the quick-boot; and
determining a core number of the last core from the retained memory.
10. The method of any of clauses 1-9, in which the accessing and the determining are performed by a central processing unit (CPU) control processor (CPUCP).
11. The method of any of clauses 1-10, further comprising initiating the deep-sleep mode in response to an off-state of a vehicle ignition.
12. A non-transitory computer-readable medium having program code recorded thereon for deep-sleep mode operation, the program code being executed by a processor and comprising:
program code to initiate a quick-boot to exit from a deep-sleep mode of a system-on-chip (SoC) having multiple cores;
program code to restore a configuration saved by a last core prior to entry of the SoC into the deep-sleep mode;
program code to enable the last core that configured the SoC for the deep-sleep mode; and
program code to enable the multiple cores and drivers to transition the SoC to an active mode.
13. The non-transitory computer-readable medium of clause 12, in which the program code to enable of the last core further comprises program code to utilize the last core to configure memory maps and an external protection unit (XPU), prior to performing a handoff to a firmware trust zone.
14. The non-transitory computer-readable medium of clause 12, in which the program code to enable of the last core further comprises program code to disable a boot-core enabled in response to triggering of the quick-boot.
15. The non-transitory computer-readable medium of any of clauses 12-14, in which program code to restore the configuration comprises:
program code to access the configuration stored in a multi-processor affinity register (MPIDR) of the last core; and
program code to store the configuration in a retained memory during the deep-sleep mode.
16. The non-transitory computer-readable medium of any of clauses 12-15, in which the program code to restore the configuration comprises:
program code to access the configuration stored in a retained memory during the deep-sleep mode; and
program code to update an SoC configuration according to the configuration accessed from the retained memory.
17. The non-transitory computer-readable medium of any of clauses 12-16, in which the program code to enable the multiple cores and drivers comprises program code to hand off the last core to a kernel operating system (OS).
18. The non-transitory computer-readable medium of clause 17, in which the program code to hand off the last core to the kernel OS is performed by trusted firmware.
19. The non-transitory computer-readable medium of any of clauses 12-18, in which the program code to initiate the quick-boot further comprises:
program code to access a retained memory in response to triggering of the quick-boot; and
program code to determine a core number of the last core from the retained memory.
20. The non-transitory computer-readable medium of clause 19, in which the program code to access and the program code to determine are performed by a central processing unit (CPU) control processor (CPUCP).
21. The non-transitory computer-readable medium of any of clauses 12-20, further comprising program code to initiate the deep-sleep mode in response to an off-state of a vehicle ignition.
22. The non-transitory computer-readable medium of any of clauses 12-21, in which the program code to enable of the multiple cores and drivers is performed by the last core.

For a firmware and/or software implementation, the methodologies may be implemented with modules (e.g., procedures, functions, etc.) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on non-transitory computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined may be applied to other variations without departing from the spirit or scope of the disclosure. Thus, the disclosure is not intended to be limited to the examples and designs described but is to be accorded the widest scope consistent with the principles and novel features disclosed.

What is claimed is:

1. A method for deep-sleep mode operation, the method comprising:
initiating a quick-boot to exit from a deep-sleep mode of a system-on-chip (SoC) having multiple cores;
restoring a configuration saved by a last core prior to entry of the SoC into the deep-sleep mode;
enabling the last core that configured the SoC for the deep-sleep mode; and
enabling the multiple cores and drivers to transition the SoC to an active mode.

2. The method of claim 1, in which the enabling of the multiple cores and drivers is performed by the last core.

3. The method of claim 1, in which the enabling of the last core further comprises utilizing the last core to configure memory maps and an external protection unit (XPU), prior to performing a handoff to a firmware trust zone.

4. The method of claim 1, in which enabling of the last core further comprises disabling a boot-core enabled in response to triggering of the quick-boot.

5. The method of claim 1, in which restoring the configuration comprises:
accessing the configuration stored in a multi-processor affinity register (MPIDR) of the last core; and
storing the configuration in a retained memory during the deep-sleep mode.

6. The method of claim 1, in which restoring the configuration comprises:
accessing the configuration stored in a retained memory during the deep-sleep mode; and
updating an SoC configuration according to the configuration accessed from the retained memory.

7. The method of claim 1, in which the enabling of the multiple cores and drivers comprises handing off the last core to a kernel operating system (OS).

8. The method of claim 7, in which the handing off the last core to the kernel OS is performed by trusted firmware.

9. The method of claim 1, in which the initiating the quick-boot further comprises:
accessing a retained memory in response to triggering of the quick-boot; and
determining a core number of the last core from the retained memory.

10. The method of claim 9, in which the accessing and the determining are performed by a central processing unit (CPU) control processor (CPUCP).

11. The method of claim 1, further comprising initiating the deep-sleep mode in response to an off-state of a vehicle ignition.

12. A non-transitory computer-readable medium having program code recorded thereon for deep-sleep mode operation, the program code being executed by a processor and comprising:
program code to initiate a quick-boot to exit from a deep-sleep mode of a system-on-chip (SoC) having multiple cores;
program code to restore a configuration saved by a last core prior to entry of the SoC into the deep-sleep mode;
program code to enable the last core that configured the SoC for the deep-sleep mode; and
program code to enable the multiple cores and drivers to transition the SoC to an active mode.

13. The non-transitory computer-readable medium of claim 12, in which the program code to enable of the last core further comprises program code to utilize the last core to configure memory maps and an external protection unit (XPU), prior to performing a handoff to a firmware trust zone.

14. The non-transitory computer-readable medium of claim 12, in which the program code to enable of the last core further comprises program code to disable a boot-core enabled in response to triggering of the quick-boot.

15. The non-transitory computer-readable medium of claim 12, in which program code to restore the configuration comprises:
program code to access the configuration stored in a multi-processor affinity register (MPIDR) of the last core; and
program code to store the configuration in a retained memory during the deep-sleep mode.

16. The non-transitory computer-readable medium of claim 12, in which the program code to restore the configuration comprises:
program code to access the configuration stored in a retained memory during the deep-sleep mode; and
program code to update an SoC configuration according to the configuration accessed from the retained memory.

17. The non-transitory computer-readable medium of claim 12, in which the program code to enable the multiple cores and drivers comprises program code to hand off the last core to a kernel operating system (OS).

18. The non-transitory computer-readable medium of claim 17, in which the program code to hand off the last core to the kernel OS is performed by trusted firmware.

19. The non-transitory computer-readable medium of claim 12, in which the program code to initiate the quick-boot further comprises:
program code to access a retained memory in response to triggering of the quick-boot; and
program code to determine a core number of the last core from the retained memory.

20. The non-transitory computer-readable medium of claim 19, in which the program code to access and the program code to determine are performed by a central processing unit (CPU) control processor (CPUCP).

21. The non-transitory computer-readable medium of claim 12, further comprising program code to initiate the deep-sleep mode in response to an off-state of a vehicle ignition.

22. The non-transitory computer-readable medium of claim 12, in which the program code to enable of the multiple cores and drivers is performed by the last core.
